(19) United States
(12) Patent Application Publication
(10) Pub. No.: US 2010/0115494 A1
(43) Pub. Date: May 6, 2010

(54) SYSTEM FOR DYNAMIC PROGRAM PROFILING

(76) Inventor: Richard C. Gorton, JR., Framingham, MA (US)

Correspondence Address: MHKKG / GLOBALFOUNDRIES, P.O. Box 398, Austin, TX, 78767-0698, US

(21) Appl. No.: 12/263,902

(22) Filed: Nov. 3, 2008

(51) Int. Cl. G06F 9/44

(52) U.S. Cl. 717/128

(57) ABSTRACT

A system and method for efficient whole program profiling of software applications. A computing system comprises a dynamic binary instrumentation (DBI) tool coupled to a virtual machine configured to translate and execute binary code of a software application. The binary code is augmented with instrumentation and analysis code during translation and execution. Characterization information of each basic block is stored as each basic block is executed. A dynamic binary analysis (DBA) tool inspects this information to identify hierarchical layers of cycles within the application that describe the dynamic behavior of the application. A sequence of basic blocks may describe paths, a sequence of paths may describe a stratum, and a sequence of strata may describe a stratum layer. Statistics of these layers and hot paths may be determined and stored. This data storage yields a whole program profile comprising program phase changes that accurately describes the dynamic behavior of the application.

### BACKGROUND OF THE INVENTION

1. Field of the Invention

This invention relates to high performance computing systems, and more particularly, to maintaining and performing efficient whole program profiling of software applications.

2. Description of the Relevant Art

Software programmers write applications to perform work according to an algorithm or a method. The program's performance may be increased based on an understanding of the dynamic behavior of the entire program. Inefficient portions of the program may be improved once the inefficiencies are known. The following program information may aid in describing a program's dynamic behavior such as code coverage, call-graph generation, memory-leak detection, instruction profiling, thread profiling, race detection, or other. In addition, understanding a program's dynamic behavior may be useful in computer architecture research such as trace generation, branch prediction techniques, cache memory subsystem modeling, fault tolerance studies, emulating speculation, emulating new instructions, or other. Generally speaking, what is needed is a single, compact description of a program's entire control flow including loop iterations and inter-procedural paths.

Accurate instruction traces are needed to determine a program's dynamic behavior by capturing a program's dynamic control flow, not just its aggregate behavior. Programmers, compiler writers, and computer architects can use these traces to improve performance. One approach to obtain instruction traces is to build a simulator, execute applications on it, and collect and compress the resulting information. This approach requires a large amount of memory and a large amount of time to complete the process. Further, a simulator may not accurately capture the dynamic behavior of the application executing on a particular hardware system (e.g., since the simulator may be operating on statistical data).

In order to reduce both memory storage and execution time required to collect data, another approach is to perform profiling on only a small subset of the application. Yet other approaches investigate only memory reference traces. Also, hot path profiling measures the frequency and cost of a program's executed paths. It is an essential technique to understand a program's control flow. However, many current path profiling techniques only capture acyclic paths. Acyclic paths end at loop iteration and procedure boundaries, and, therefore, these paths do not describe the program's flow through procedure boundaries and loop iterations. Without tools to efficiently identify expensive inter-procedural paths, it is difficult to improve the performance of software. However, these approaches do not capture whole program profiling of the application. Further, as processor speeds have increased, it has become more difficult to collect complete execution traces for applications. This is in part due to the sheer number of instructions in such a trace, and also in part due to the performance overhead required to capture these traces.

In view of the above, efficient methods and mechanisms for maintaining efficient whole program profiling of software applications is desired.

### SUMMARY OF THE INVENTION

Systems and methods for efficient whole program profiling of software applications.

In one embodiment, a computing system is provided comprising a dynamic binary instrumentation (DBI) tool coupled to a virtual machine configured to translate and execute binary code of a software application. The binary code is augmented with instrumentation and analysis code during translation and execution. Characterization information of each basic block is stored as each basic block is executed. This information is inspected by a dynamic binary analysis (DBA) tool in order to identify hierarchical layers of cycles within the application that describe the dynamic behavior of the application. For example, a sequence of basic blocks may describe paths, a sequence of paths may describe a stratum, and a sequence of strata may describe a stratum layer. Statistics such as hot paths may be determined and stored in tables, files, and/or logfiles. The data storage may yield a whole program profile comprising program phase changes that accurately describes the dynamic behavior of the application.

In another embodiment, a computer readable storage medium stores program instructions operable to inspect stored characterization information of basic blocks as the corresponding software application executes. The instructions identify hierarchical layers of cycles within the application that describe the dynamic behavior of the application. Statistics such as hot paths may be integrated with the hierarchical layers and stored in tables, files, and/or logfiles. This data storage yields a whole program profile.

### BRIEF DESCRIPTION OF THE DRAWINGS

FIG. 1 is a generalized block diagram illustrating one embodiment of an exemplary processing subsystem.

FIG. 2 is a generalized block diagram illustrating one embodiment of hierarchical layers of cycles within a software application.

FIG. 3 is a generalized block diagram of one embodiment of program analysis flows.

FIG. 4 is a generalized block diagram of one embodiment of a computing system.

FIG. 5 is a flow diagram of one embodiment of a method for identifying paths and repeated paths within the dynamic behavior of a software application.

FIG. 6 is a is a flow diagram of one embodiment of a method for processing a repeated path prior to stratum processing.

FIG. 7 is a flow diagram of one embodiment of a method for identifying stratum and repeated strata within the dynamic behavior of a software application.

FIG. 8 is a flow diagram of one embodiment of a method processing a repeated stratum prior to stratum layer processing.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

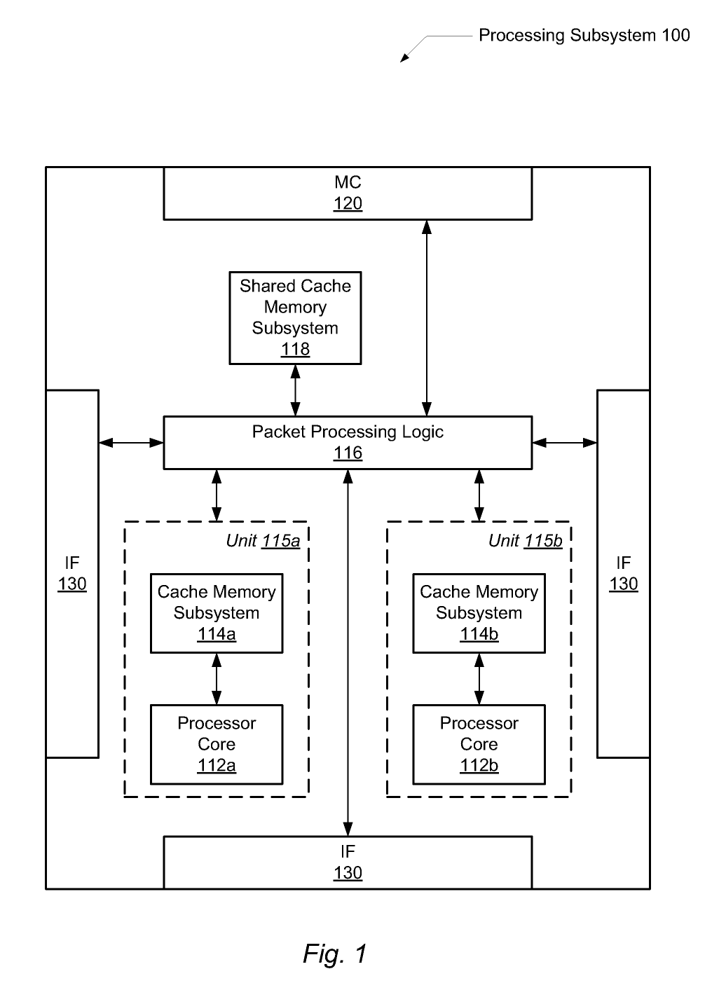

FIG. 1 is a block diagram of one embodiment of an exemplary processing subsystem 100. Processing subsystem 100 may include memory controller 120, interface logic 140, one or more processing units 115, which may include one or more processor cores 112 and a corresponding cache memory subsystems 114; packet processing logic 116, and a shared cache memory subsystem 118. Processing subsystem 100 may be a node within a multi-node computing system. In one embodiment, the illustrated functionality of processing subsystem 100 is incorporated upon a single integrated circuit.

Processing subsystem 100 may be coupled to a respective memory via a respective memory controller 120. The memory may comprise any suitable memory devices. For example, the memory may comprise one or more RAMBUS dynamic random access memories (DRAMs), synchronous DRAMs (SDRAMs), DRAM, static RAM, etc. Processing subsystem 100 and its memory may have its own address space from other nodes, or processing subsystems. Processing subsystem 100 may include a memory map used to determine which addresses are mapped to its memory. In one embodiment, the coherency point for an address within processing subsystem 100 is the memory controller 120 coupled to the memory storing bytes corresponding to the address. Memory controller 120 may comprise control circuitry for interfacing to memory. Additionally, memory controllers 120 may include request queues for queuing memory requests.

Outside memory may store instructions of a software application. If the dynamic behavior of this software application is known, improvements may be made to the application to increase performance. For purposes of discussion, a basic block may be defined as a straight-line sequence instructions within a program, whose head, or first instruction, is jumped to from another line of code, and which ends in an unconditional control flow transfer such as a jump, call, or return. A path within the application may be defined as a sequence of unique basic blocks (Bbs) such that the next executed Bb may result in a cycle, wherein a match of a previously processed Bb in the construction of the current path completes the cycle. A sequence of basic blocks (Bbs) may be shown as Bb₀, Bb₁, Bb₂, Bb₁. Alternatively, for visual ease of the representation, the first basic block in the sequence may be represented as “A”, wherein Bb₀=A. The same is true for subsequent basic blocks: Bb₁=B, Bb₂=C, and so forth. Therefore, the example sequence may be shown as A B C B.

If a sequence of basic blocks is “A B C D B . . . ” then the first path constructed may be “A B C D”, and the second path constructed may start with the second “B”. In addition, a cost, or a weight, may be associated with each Bb, such as the total number of instructions within the Bb, the number of a certain type of instruction within the Bb, or other. During program profiling, this weight may be summed or averaged over all the instructions within the basic block to generate a “heat” value for a path. The “heat” of the path may be multiplied by the frequency of the path during dynamic execution, wherein the frequency may be measured by use-counters. This generated “hot” information allows investigation into the program behavior such as program phase changes. Program phase changes may find a “hot” spot at a time t0 during execution, but this “hot” spot may not exist at time t1, t2, or other. Also, such hot path program profiling may be useful in determining library interactions and information on dynamic instruction mix such as the number of instructions of a certain type, whether the application is instruction fetch bound, or other.

One or more processing units 115a-115b may include the circuitry for executing instructions of the application. As used herein, elements referred to by a reference numeral followed by a letter may be collectively referred to by the numeral alone. For example, processing units 115a-115b may be collectively referred to as processing units 115. Within processing units 115, processor cores 112 include circuitry for executing instructions according to a predefined general-purpose instruction set. For example, the x86 instruction set architecture may be selected. Alternatively, the Alpha, PowerPC, or any other general-purpose instruction set architecture may be selected. Generally, processor core 112 accesses the cache memory subsystems 114, respectively, for data and instructions.

Cache subsystems 114 and 118 may comprise high speed cache memories configured to store blocks of data. Cache memory subsystems 114 may be integrated within respective processor cores 112. Alternatively, cache memory subsystems 114 may be coupled to processor cores 114 in a backside cache configuration or an inline configuration, as desired. Still further, cache memory subsystems 114 may be implemented as a hierarchy of caches. Caches which are nearer processor cores 112 (within the hierarchy) may be integrated into processor cores 112, if desired. In one embodiment, cache memory subsystems 114 each represent L2 cache structures, and shared cache subsystem 118 represents an L3 cache structure.

Both the cache memory subsystem 114 and the shared cache memory subsystem 118 may include a cache memory coupled to a corresponding cache controller. If the requested block is not found in cache memory subsystem 114 or in shared cache memory subsystem 118, then a read request may be generated and transmitted to the memory controller within the node to which the missing block is mapped.

Generally, packet processing logic 116 is configured to respond to control packets received on the links to which processing subsystem 100 is coupled, to generate control packets in response to processor cores 112 and/or cache memory subsystems 114, and to generate probe commands and response packets in response to transactions selected by memory controller 120 for service. Interface logic 130 may include logic to receive packets and synchronize the packets to an internal clock used by packet processing logic 116.

Additionally, processing subsystem 100 may include interface logic 130 used to communicate with other subsystems. Processing subsystem 100 may be coupled to communicate with an input/output (I/O) device (not shown) via interface logic 130. Such an I/O device may be further coupled to a second I/O device. Alternatively, a processing subsystem 100 may communicate with an I/O bridge, which is coupled to an I/O bus.

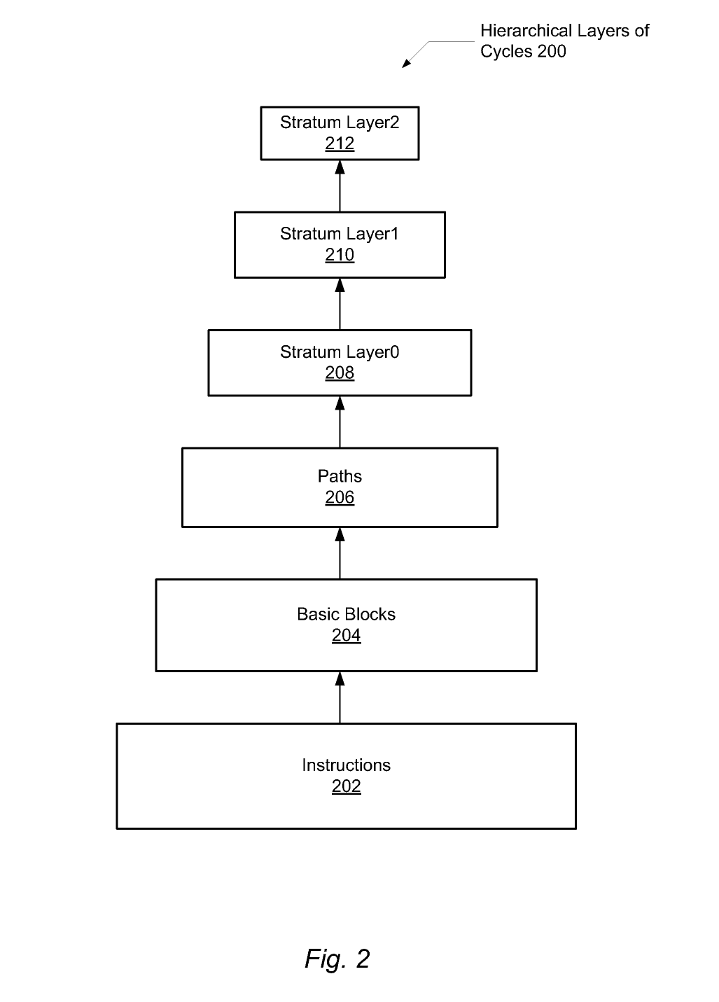

Referring to FIG. 2, one embodiment of hierarchical layers 200 of cycles within an application is shown. Such layers may be of interest regarding capturing the dynamic behavior of an executing application within a whole program profile. An executing application may have time varying behavior. Within a sequence of two or more predetermined time intervals, an application may exhibit a difference in a number of memory accesses performed, a number of instructions executed, or other. The difference may, for example, be due to the application executing code in a different library or due to executing code in different routines of a same library.

A program profile may include program phase changes. However, phases may not be well defined, and may be determined by the user for a particular improvement being studied. As one example, a conditional branch counter may be used to detect program phase changes. The counter may record the number of dynamic conditional branches executed over a fixed execution interval, which may be measured in terms of the dynamic instruction count. Phase changes may be detected when the difference in branch counts of consecutive intervals exceeds a predetermined threshold.

Another example of a program phase may be the instruction working set of the program, or the set of instructions touched in a fixed interval of time. The use of subroutines may be used to identify program phases. A hardware based call stack may identify program subroutines. The call stack tracks time spent in each subroutine, taking into consideration nesting of subroutines. If the time spent in a subroutine is greater than a predetermined threshold, then a phase change has been identified. The execution frequencies of basic blocks within a particular execution interval may define another phase change.

The instructions 202 of an application may be grouped into basic blocks 204, wherein basic blocks 204 may consist of one or more code statements terminated by an unconditional jump instruction. A particular basic block 204 may be identified by the address of its corresponding first instruction. As described earlier, a path 206 within the application may be defined as a sequence of unique basic blocks (Bbs) such that the next executed Bb may result in a cycle, wherein a match of the current Bb compared to a previously processed Bb in the construction of the current path completes the cycle. Table 1 below displays an example of a sequence of Bbs and one embodiment of the resulting paths 206. The initial three Bbs (e.g. A B C) are defined as the first path, Path 0. The fourth Bb (e.g. the second B) is defined as the second path, Path 1, and so forth.

TABLE 1
Construction of Initial Layers of Cycles

| Sequence of Bbs | A B C B B C B |
|---|---|
| Path 0 | A B C |
| Path 1 | B |
| Path 2 | B C |
| Path 3 | B |

A repeated path (RP) is the set of consecutive occurrences of a particular path. For example, if a path 4, or P₄, which is not shown above, consecutively repeats 3 times, then its corresponding repeated path may be defined as P₄³. A stratum may be defined as a cycle of repeated paths, or a sequence of repeated paths (RPs) such that the next executed RP will result in a cycle. Basically, the above definition for a path may have RP substituted for Bb in order to define a stratum (S). For example, if a sequence of RPs is P₀⁷, P₁¹², P₀⁵, P₁¹², then the corresponding strata may be S₀=P₀⁷, P₁¹², P₀⁵ and S₁=P₁¹².

A Repeated Stratum 0 (RS₀) is the set of consecutive occurrences of a particular Stratum 0 (S₀). A stratum layer 0 (SL₀) 208 may be defined as a cycle of repeated stratum. Analysis beyond stratum layer 0 may become highly computation intensive. However, further stratum layer 1, stratum layer 2, and so forth, are possible to compute if desired.

In order to detect or identify basic blocks in order to track a sequence of basic blocks (e.g. A B C B B) during execution of a software application, the application program may be instrumented. Program instrumentation may comprise augmenting code with new code in order to collect runtime information. Generally speaking, to instrument code refers to the act of adding extra code to a program for the purpose of dynamic analysis. Also, the code added during instrumentation is referred to as the instrumentation code. It may also be referred to as analysis code. The code that performs the instrumentation is not referred to as instrumentation code. Rather, this code resides in an instrumentation toolkit, which is further explained shortly. In one embodiment, the analysis code may be inserted entirely inline. In another embodiment, the analysis code may include external routines called from the inline analysis code. The analysis code is executed as part of the program's normal execution. However, the analysis code does not change the results of the program's execution, although the analysis code may increase the required execution time.

The instrumentation of code is used during dynamic analysis, which comprises analyzing a client's program, or software application, as it executes. In contrast, static analysis comprises analyzing a program's source code or machine code without executing the code. A compiler is one example of a tool that comprises stages or function blocks that perform static analysis for type checking, identifying “for” and “while” loop constructs for an optimization stage, or other. Although, a compiler may have dynamic stages or function blocks for dynamic compilation such as a Just-In-Time (JIT) compiler. Static analysis only needs to read a program in order to analyze it. The instrumentation of code is not utilized during static analysis. Therefore, the following discussion focuses on dynamic analysis, and static analysis is not considered any further beyond certain front-end and back-end compiler stages.

Also, the instrumentation of code is used during binary analysis, which comprises analyzing programs at the level of machine code, stored either as object code prior to a linking stage of a compiler or as executable code subsequent the linking stage of the compiler. Binary analysis also, regarding dynamic JIT compiling, includes analyses performed at the level of executable intermediate representations, such as byte-codes, which run on a virtual machine. In contrast, source analysis comprises analyzing programs at the level of source code. A compiler, again, is an example of a tool that performs source analysis such as front-end stages of compilation. Although, a compiler also performs binary analysis in later stages of compilation. Source analysis is platform-independent, such as the architecture and the operating system (OS) of the system, but it is language-specific. Binary analysis is language-independent but platform-specific.

An advantage of binary analysis over source analysis is that the original source code is not required. Therefore, library code, which the source code is often not available on systems, is also not required. In one embodiment, performing dynamic analysis and instrumentation on source code may be performed. In a preferred embodiment, binary analysis, or specifically, dynamic binary analysis is performed. In one embodiment, dynamic analysis and instrumentation is performed on an intermediate representation (IR), or bytecode. In a preferred embodiment, dynamic binary analysis, comprising instrumentation, is performed on machine code.

The binary instrumentation of code may be performed statically or dynamically. Static binary instrumentation (SBI) occurs prior to the execution of a program. The process of SBI rewrites object code or executable code. SBI may comprise receiving the executable binary code as an input, adding the instrumentation code and analysis code to the binary code at desired locations, and generate new machine code with instrumentation code to be loaded and executed. Examples of static instrumentation toolkits include ATOM and Vulcan.

Dynamic binary instrumentation (DBI) occurs at run-time. Dynamic binary instrumentation may comprise modifying the original executable machine code with instrumentation code and analysis code as the original machine code is executing. This additional code can be injected by a program grafted onto the client process, or by an external process. If the software application comprises dynamically-linked code, then the analysis code needs to be added subsequent the processing of the dynamic linker.

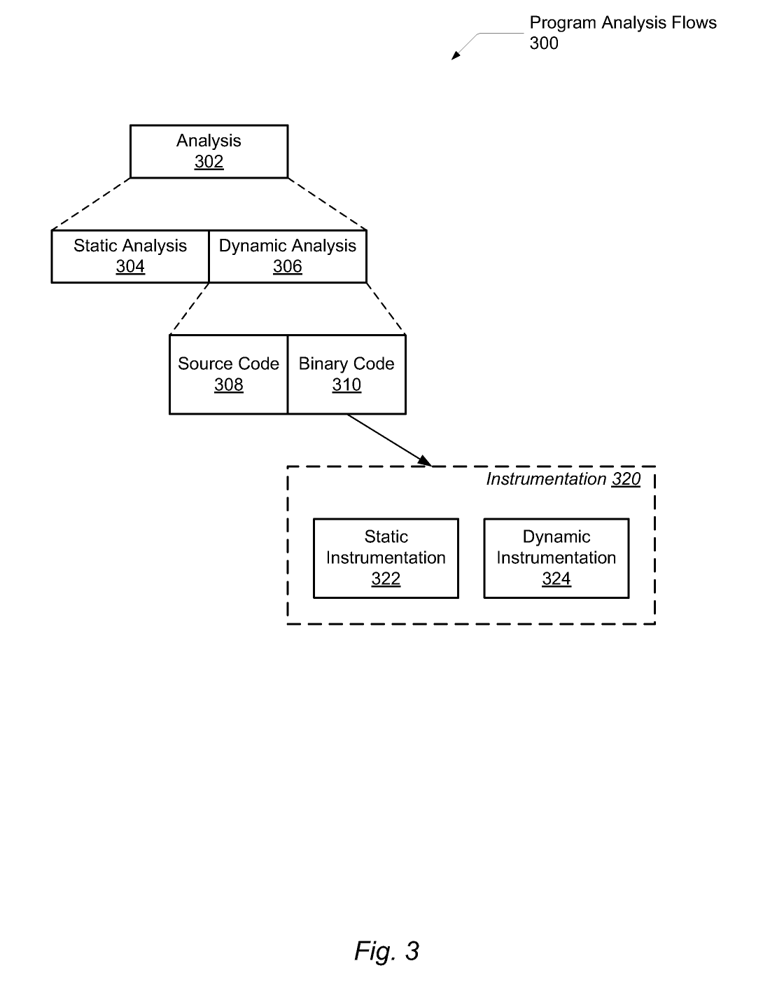

In one embodiment, the binary instrumentation of machine code is static (SBI). In a preferred embodiment, the binary instrumentation of executable binary code is dynamic (DBI). Turning now to FIG. 3, one embodiment of program analysis flows 300 is shown. As discussed earlier, analysis 302 of a software application may be static 304, or does not require execution of the application. Alternatively, analysis 302 may be dynamic 306, or does require execution of the application. In one embodiment, dynamic analysis 306 may be performed on source code 308. Such an analysis may require instrumentation of the source code 308 itself followed by compilation of the resulting code. The subsequent compilation may be static or dynamic. These steps are possible to implement, but not shown. Maintaining analysis of source code 308 may not be desirable due to a lack of library support and other reasons. A preferred embodiment of an analysis flow 300 is dynamic analysis 306 on binary code 310, such as machine code. It is noted that binary code 310 has already been compiled either statically or dynamically. Later partial (re)compiles of the binary code 310 correspond with instrumentation 320.

Binary code 310 may be augmented by instrumentation 320, which, in one embodiment, may be static 322, or prior to run-time of the executable code. Such a flow may require static compilation, wherein instrumentation libraries or tools insert analysis code. This insertion step may occur prior to linking or subsequent to linking within the back-end compilation stage. The new, augmented code is then ready to be executed and provide statistics for performance studies or debugging techniques.

In a preferred embodiment, binary code 310 may be augmented by dynamic instrumentation 324, which occurs at run-time. In one embodiment, a dynamic binary instrumentation (DBI) tool grafts itself into the client process at start-up, and then partially (re)compiles the binary code of the software application, one basic block at a time, in a just-in-time (JIT), execution manner. This (re)compilation process may comprise disassembling the machine code into an intermediate representation (IR) which is instrumented by a tool plug-in.

The user writes instrumentation and analysis routines, which may interface with an application programming interface (API) of the DBI tool. The instrumentation is customizable. The user decides where analysis calls are inserted, the arguments to the analysis routines, and what the analysis routines measure. The instrumented IR may then be converted back into binary code, which is referred to as a translation. This translation may be stored in a code cache to be executed as necessary. The processor core(s) spends its execution time generating, locating, and executing translations.

For example, an instrumentation toolkit may be instructed to insert code at basic block boundaries within the application program. In one embodiment, the following information may be collected from the application by the instrumentation code at the basic block boundaries: basic block address, “heat” of the basic block, and basic block disassembly. The “heat” of the basic block may be a measure of how much time a particular basic block requires to execute. In one embodiment, the “heat” may simply be the number of instructions in the basic block. In other embodiments, the “heat” may be measure of a number of a certain type of instruction within the corresponding basic block, a total number of clock cycles required for an execution of the basic block, a total number of cache misses, or other.

Information regarding instruction types may be derived from the basic block disassembly also. The basic block disassembly is machine code presented in a human-readable formal language format, such as the assembly language of the target platform. The disassembly may be presented in hex bytes. Typically, basic block disassembly is used with debugging tools. Also, since assembling to machine code, which may occur during back-end compilation, removes all traces of labels from the code, the object file format has to keep these values stored in different places. A symbol table may be used for this purpose. The symbol table may contain a list of label names and their corresponding offsets in the text and data segments. A disassembler provides support for translating back from an object file or an executable file.

Dynamic compilation and caching, such as with a code cache, is an alternative to interpreted execution with a different trade-offs. By taking the extra space to store the (re)compiled code, repeating operations such as instruction decoding are avoided. Also, by translating entire basic blocks, performance may be further improved with intra-basic-block optimizations.

The DBI tool sees every instruction in the user process that is executed, including the dynamic loader and all shared libraries. The instrumentation and analysis execute in the same address space as the application, and can see all the application's data. The DBI tool passes instructions or a sequence of instructions (trace) to an instrumentation routine. It does not use the same memory stack or heap area as the application, and maps addresses in a special area. Addresses of local variables (stack) and addresses returned by calls are not changed. Other embodiments of a DBI tool are possible and contemplated.

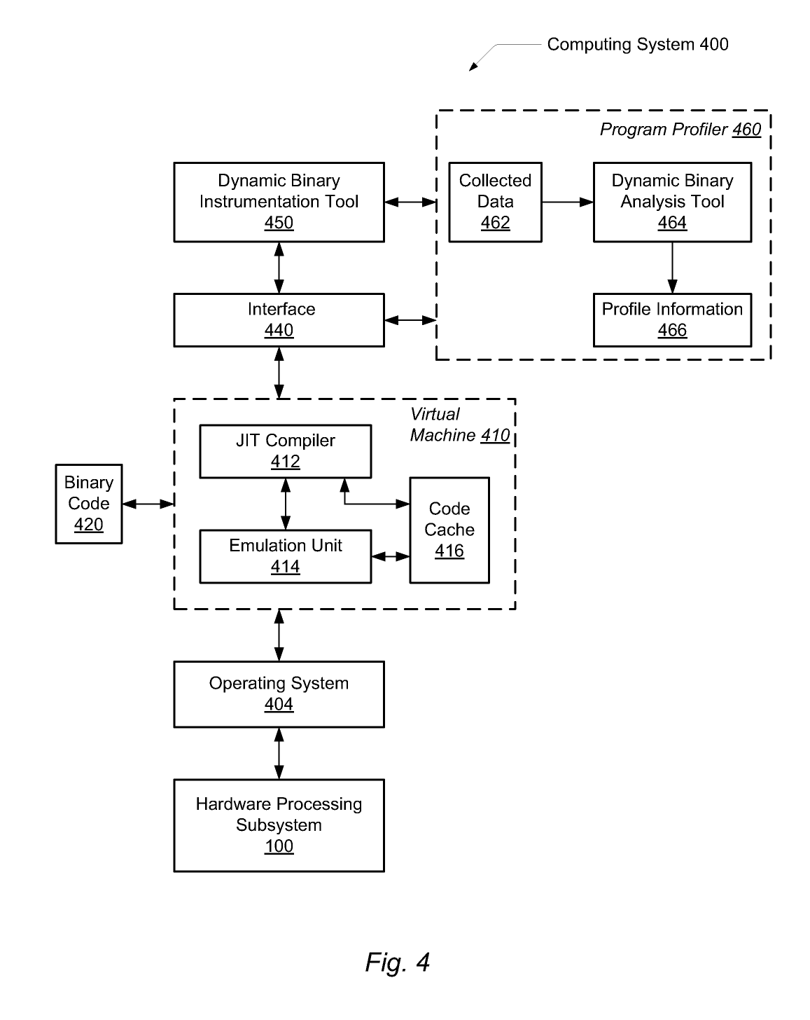

Turning now to FIG. 4, one embodiment of a computing system 400 for whole program profiling is shown. In one embodiment, hardware processing subsystem 100 has the same circuitry as shown in FIG. 1. Operating system 404 manages the operation of the hardware in subsystem 100, which relieves application programs from having to manage details such as allocating regions of memory for a software application. The multiple processes of a compiled software application may require its own resources such as an image of memory, or an instance of instructions and data before application execution. Each process may comprise process-specific information such as address space that addresses the code, data, and possibly a heap and a stack; variables in data and control registers such as stack pointers, general and floating-point registers, program counter, and otherwise; and operating system descriptors such as stdin, stdout, and otherwise, and security attributes such as processor owner and the process' set of permissions.

Virtual machine 410 executes programs as if it is the hardware platform. Virtual machine 410 may execute programs that were written for the computer processor architecture within subsystem 100, which may be referred to as native execution. Virtual machine emulates the hardware of subsystem 100. Alternatively, virtual machine 410 may execute programs that were written for another computer processor architecture outside of subsystem 100. In this case, virtual machine 410 emulates the hardware of an outside processor architecture with the aid of emulation unit 414. Dynamic binary translation performed by virtual machine 410 permits this interesting feature that executing binary code 420 may be separated from the underlying hardware in subsystem 100.

Virtual machine 410 may support dynamic compilation, such as Just-In-Time (JIT) compilation with JIT compiler 412. Binary code 420 may be an application that has already been compiled and currently resides in system memory or the cache memory subsystem of hardware processing subsystem 100. Dynamic compilation performed by JIT compiler 412 within virtual machine 410 may also perform dynamic binary translation, which allows a software application of an arbitrary guest architecture to be executed on a computing system 400 with a different host architecture within subsystem 100. Therefore, the software and hardware may evolve independently. The dynamically translation output of binary code 420 is stored in code cache 416 for execution. The performance improvement over interpreters originates from caching the results of translated blocks, such as basic blocks, of binary code 420 into code cache 416. Now each line or operand is not reevaluated each time it is encountered. It also has advantages over statically compiling the code at development time, as it can partially recompile the binary code 420 if this is found to be advantageous, and may be able to enforce security guarantees.

Interface 440 may comprise application programming interfaces (APIs) for dynamic binary instrumentation (DBI) tool 450. Interface 440 may allow a user to determine what instrumentation routines and analysis routines may be augmented to binary code 420 by DBI tool 450. Generally speaking, APIs are architecture independent. The APIs may be call-based and provide functionalities to determine control flow changes, memory accesses, or other. Instrumentation routines define where instrumentation code is inserted such as before an instruction and they occur the first time an instruction is executed. Analysis routines define the functionality of the instrumentation when the instrumentation is activated. An example is an increment counter. These routines occur each time an instruction is executed.

In a preferred embodiment, the DBI tool 450 is dynamic. The DBI tool 450 may modify the binary code 420 with instrumentation and analysis code as the binary Is code 420 is executing. As the binary code 420 is being augmented and executed, the DBI tool 450 may convey characteristic information to the program profiler 460 to be stored in collected data 462. The characterization information may comprise for each basic block at least one or more of the address of the first instruction, the “heat” value of the basic block, and the disassembly of each instruction of the basic block.

The dynamic binary analysis (DBA) tool 464 may read the contents of collected data 462 in order to identify a path. As described earlier, and shown in Table 1, a path within the binary code 420 may be defined as a sequence of unique basic blocks (Bbs) such that the next executed Bb may result in a cycle, wherein a match of a previously processed Bb in the construction of the current path completes the cycle. The DBA tool 464 may be used to collect the complete dynamic instruction stream of an arbitrary thread of an application for a given dataset, in an efficient, compact fashion. In one embodiment, it may not attempt to account for interactions between threads. It may only function on single-threaded applications.

In one embodiment, the dynamic binary analysis (DBA) tool 464 may compress the accumulative characterization information and corresponding identification information of a path prior to storing this complete path information. In one embodiment, the path information may be compressed using a context-free grammar, such as algorithmic compression on the set of executed paths. The compressed version of the set of paths may be stored in a hash table. The compressed set of paths may then be analyzed to find “hot” paths simply by performing sorting on the set of paths for the “hot” values without any further post-processing of the compressed output. Recall, the “hot” values may be derived from the “heat” values of basic blocks as described earlier.

Next, the DBA tool 464 may analyze the compressed set of paths simultaneously as the binary code 420 is being translated, instrumented, and executed in order to identify repeated paths. The repeated paths may be used to later identify strata, repeated stratum, and a stratum layer as described earlier regarding the hierarchical layers of cycles in FIG. 2. In one embodiment, compression may occur prior to storage of strata, repeated strata, and the stratum layer. In one embodiment, each of the repeated paths is given a unique “strata” identifier. An identified sequence of repeated strata may then be compressed and stored to an indexed sequential access method (ISAM) file. Each record of information in the ISAM file may be accessed by an ending instruction number, ending path number, an ending strata number, or other. Profile information 466, such as he combination of the stored data in hash tables and the ISAM file, provides a whole program profile that may be used to characterize the dynamic behavior of binary code 420 such as program phase changes and other.

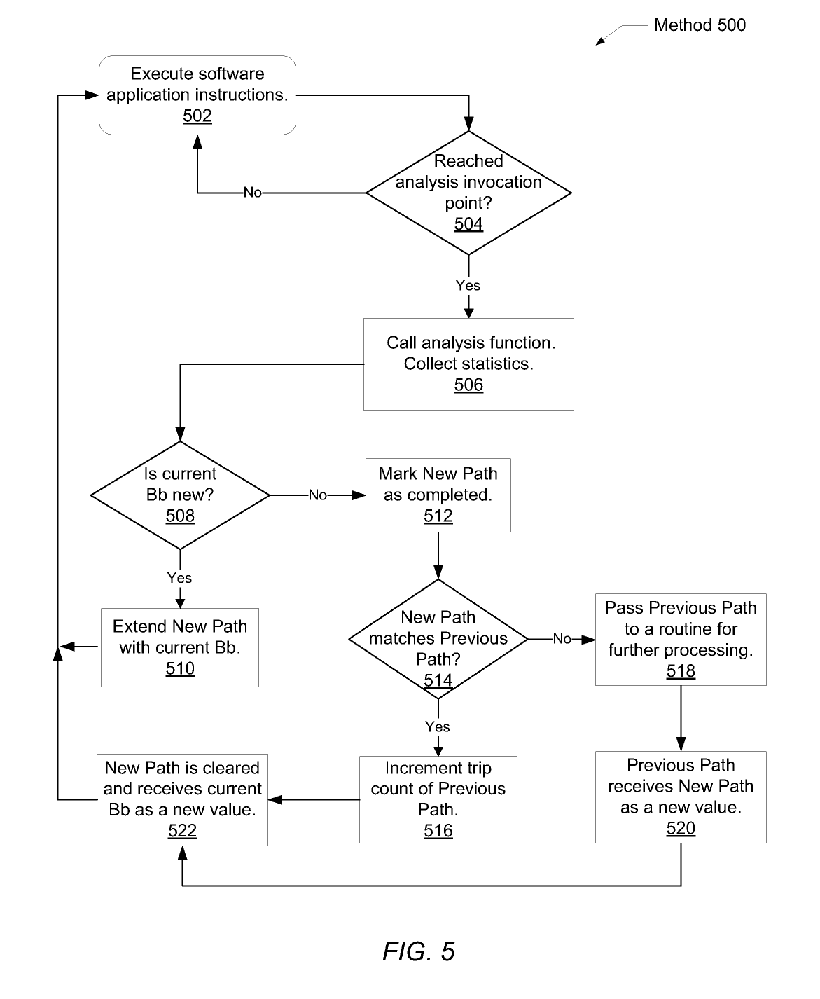

Turning now to FIG. 5, one embodiment of a method 500 for identifying paths and repeated paths within the dynamic behavior of binary code is shown. For purposes of discussion, the steps in this embodiment and subsequent embodiments of methods described later are shown in sequential order. However, some steps may occur in a different order than shown, some steps may be performed concurrently, some steps may be combined with other steps, and some steps may be absent in another embodiment.

In block 502, instructions of binary code, such as machine code, of asoftware application may be loaded, translated, instrumented, and executed. In one embodiment, the instrumentation code and analysis code may be augmented to the translated binary code according to directives given by a user via a dynamic binary instrumentation (DBI) tool. In one embodiment, each time a basic block boundary, such as the head or the end, is encountered (conditional block 504), an analysis function call may be invoked and characterization information of the basic block may be compressed and stored, or simply stored, in block 506. Storage may utilize a hash table. The characterization information corresponding to the current basic block may include one or more of the following: an address of the first instruction of the basic block, the weight or “heat” value, disassembly of the instructions, or other. In another embodiment, the DBI tool may utilize a more efficient location in the code to invoke an analysis function call other than a basic block boundary. For example, another location within the basic block other than the start or finish may require less context, or data corresponding to system registers, virtual addresses, or other information pertaining to the execution of a particular thread or process, to be saved due to the instruction sequence.

If the current identified basic block (Bb) is new (conditional block 508), or it does not match a previously processed Bb in the construction of a sequence of unique Bbs, or current path, then the current path is extended with the current Bb and control flow of method 500 returns to block 502. Otherwise, if the current identified Bb is not new (conditional block 508), then the current path, or New Path, is marked as completed in block 512.

A comparison is performed between the stored values the New Path and a Previous Path (conditional block 514). This comparison may include a comparison of unique identifiers assigned to each path, a comparison of predetermined fields of each path, or other. If the New Path matches the Previous Path (conditional block 514), then a trip count of the Previous Path is incremented in block 516. A pointer, identifier, storage element, or other corresponding to Previous Path continues to correspond to the current value of the Previous Path, but with an incremented trip count. In block 522, the pointer, identifier, storage element, or other corresponding to New Path does not continue to correspond to the current value of New Path. Rather the value of New Path is cleared and subsequently extended with the value of the current Bb.

For example, if a sequence of Bbs is “A B C A B C B” and method 500 is currently processing the third B in the sequence, then the current values of both the Previous Path, which may designated as P₀, and New Path, P₁, may be “A B C”, P₀=P₁=A B C. A comparison and subsequent match of P₀ and P₁ causes the trip count of P0 to increment and Previous Path now may be designated as P₀². New Path, P₁, is cleared and now has the value “B”. Control flow of method 500 returns to block 502.

If the New Path does not match the Previous Path (conditional block 514), then the Previous Path is passed to a routine for further processing in block 518. This further processing may be use the value of the Previous Path to identify repeated paths, strata, repeated stratum, and a stratum layer as described earlier regarding FIG. 2. A pointer, identifier, storage element, or other corresponding to Previous Path no longer continues to correspond to the current value of the Previous Path. Rather, the value of the Previous Path is now replaced by the value of the New Path in block 520.

For example, if a sequence of Bbs is “A B C A B D A” and method 500 is currently processing the third A in the sequence, then the current values of both the Previous Path, which may designated as P₀, and New Path, P₁, may be “A B C” and “A B D” respectively; P₀=A B C, and P₁=A B D. A comparison and subsequent mismatch of P₀ and P₁ causes the value of P₀, “A B C” and its corresponding trip count to be passed along for further processing and the new value of the Previous Path is now the current value of the New Path, or now P₀=A B D. Next the value of the New Path is cleared or reset and replaced with the value of the current Bb, or now P₁=A. Control flow of method 500 moves to block 522.

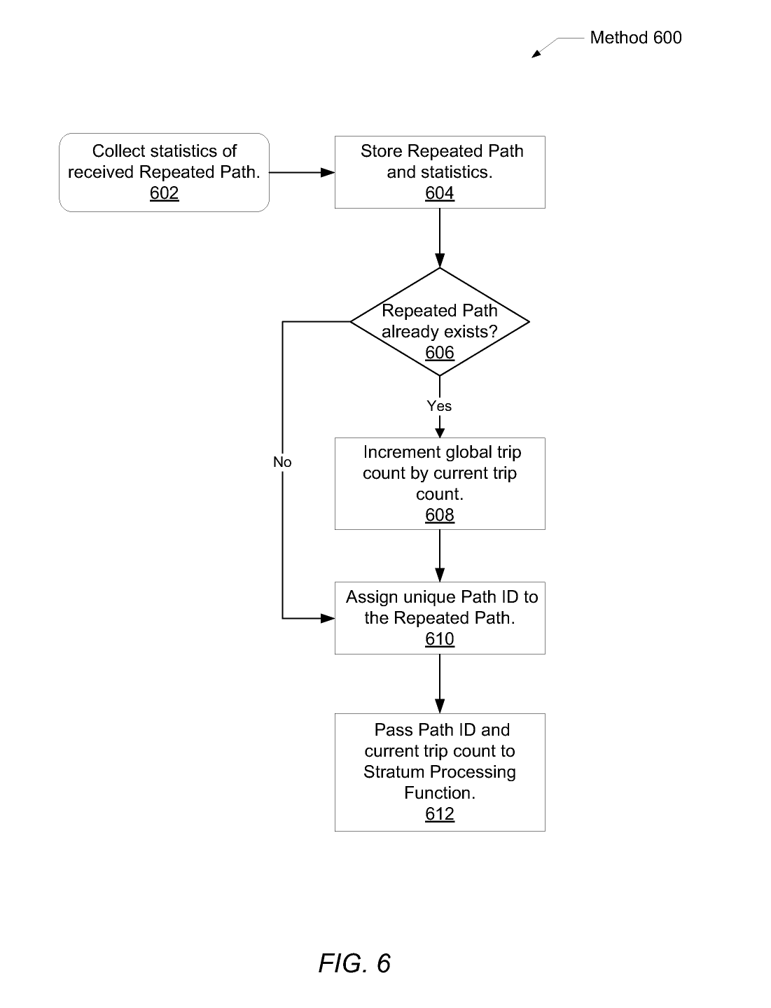

Referring now to FIG. 6, one embodiment of a method 600 for processing a repeated path prior to stratum processing is shown. As with method 500 and other methods described herein, the steps in this embodiment and subsequent embodiments of methods described later are shown in sequential order. However, some steps may occur in a different order than shown, some steps may be performed concurrently, some steps may be combined with other steps, and some steps may be absent in another embodiment.

Method 600 may correspond to processing steps subsequent to block 518 of method 500. Predetermined statistics of the received repeated path are collected in block 602. These statistics and information corresponding to the sequence of Bbs within the path are stored in block 604. In one embodiment, the statistics and information are compressed prior to being stored in a hash table. If this particular repeated path has been processed earlier in dynamic program execution (conditional block 606), then a corresponding global trip count is incremented by the current trip count of the repeated path in block 608.

Whether or not this repeated path has been processed earlier, a unique path identifier (ID) is assigned to this repeated path in block 610. The path ID and current trip count of the repeated path are then passed to a stratum processing function in block 612.

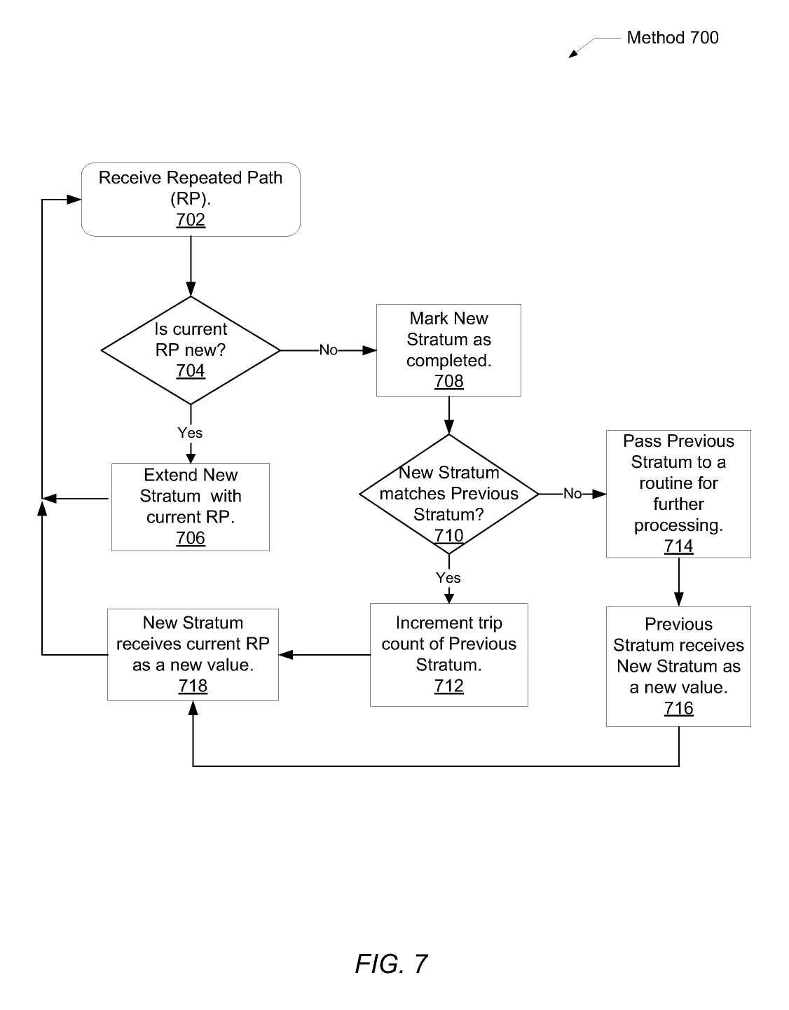

Turning now to FIG. 7, one embodiment of a method 700 for identifying stratum and repeated strata within the dynamic behavior of binary code is shown. In one embodiment, method 700 parallels method 500, wherein a basic block is replaced by a repeated path and a path is replaced by a stratum.

In block 702, a repeated path that has been passed by method 500, processed, compressed, and stored may be received by method 700. Blocks 704-718 may parallel blocks 508-522 of method 500. Blocks 704-718 may have the same functionality as blocks 508-522, except a sequence of repeated paths corresponding to dynamic behavior or a binary code execution are used to identify strata and repeated strata versus basic blocks are used to identify paths and repeated paths.

For example, if a sequence of repeated paths (RPs) is “P₀⁷, P₁¹², P₀⁵, P₀⁷, P₁¹², P₀⁵, P₁¹²” and method 700 is currently processing the third RP, P₁¹², in the sequence, then the current values of both the Previous Stratum, which may designated as S₀, and New Stratum, S₁, may be “P₀⁷, P₁¹², P₀⁵”, or S₀=S₁=“P₀⁷, P₁¹², P₀⁵”. A comparison and subsequent match of S₀ and S₁ causes the trip count of S₀ to increment and Previous Stratum now may be designated as S₀². New Stratum, S₁, is cleared and now has the value “P₁¹²”.

In another example, if a sequence of RPs is “P₀⁷, P₁¹², P₀⁵, P₀⁷, P₁¹², P₂⁴, P₀⁷” and method 700 is currently processing the third P₀⁷ in the sequence, then the current values of both the Previous Stratum, which may designated as S₀, and New Stratum, S₁, may be “P₀⁷, P₁¹², P₀⁵” and “P₀⁷, P₁¹², P₂⁴” respectively. A comparison and subsequent mismatch of S₀ and S₁ causes the value of S₀ and its corresponding trip count to be passed along for further processing in block 714. The new value of the Previous Stratum is now the current value of the New Stratum, or now S₀=“P₀⁷, P₁¹², P₂⁴”. Next the value of the New Stratum is cleared or reset and replaced with the value of the current RP, or now S₁=P₀⁷.

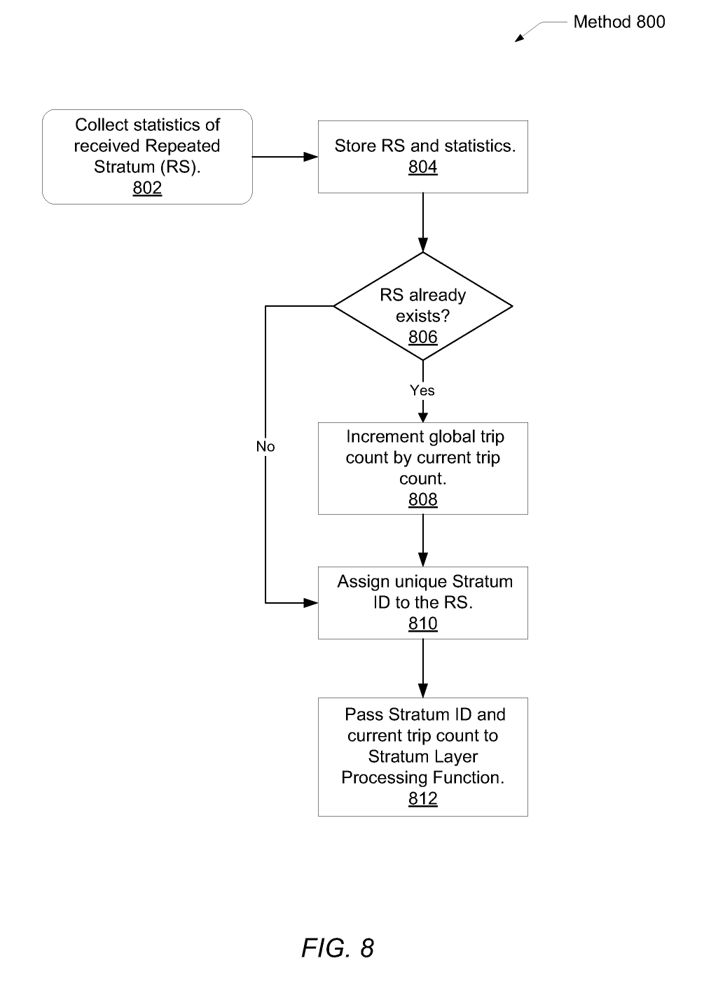

Referring now to FIG. 8, one embodiment of a method 800 for processing a repeated stratum prior to stratum layer processing is shown. In one embodiment, method 800 parallels method 600, wherein a repeated path is replaced by a repeated stratum and a stratum is replaced by a stratum layer. Method 800 may correspond to processing steps subsequent to block 714 of method 700. Predetermined statistics of the received repeated stratum are collected in block 802. These statistics and information corresponding to the sequence of repeated paths within the stratum are stored in block 804. In one embodiment, the statistics and information are compressed prior to being stored in a hash table. Blocks 806-812 may have the same functionality as blocks 606-612, except a sequence of repeated paths corresponding to dynamic behavior or a binary code execution are used to identify strata and repeated strata versus basic blocks are used to identify paths and repeated paths. The functionality of methods 700 and 800 may be repeated in further methods, wherein a sequence of repeated strata corresponding to dynamic behavior of a binary code execution are used to identify a stratum layer versus repeated paths are used to identify strata and repeated strata.

Analysis beyond a stratum layer₀ (SL₀) may be highly computationally bound. If the methods become computationally bound, the definition of a stratum may change to only fully track a stratum whose length has 4 or less repeated paths. Similar alterations are possible and contemplated. The functionality of methods 500-800 may be used to continue processing in order to determine a SL₁, a SL₂, and so forth. Upon completion at the desired layer, the path, stratum, and stratum layer tables may be written to files and these files may be summarized by logfiles. These files and logfiles may provide a whole program profile of a software application that captures the dynamic behavior of the application including program phase changes.

Various embodiments may further include receiving, sending or storing instructions and/or data that implement the above described functionality in accordance with the foregoing description upon a computer readable medium. Generally speaking, a computer readable storage medium may include one or more storage media or memory media such as magnetic or optical media, e.g., disk or CD-ROM, volatile or non-volatile media such as RAM (e.g., SDRAM, DDR SDRAM, RDRAM, SRAM, etc.), ROM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for program profiling, the method comprising:
executing program code of a program;
instrumenting said program code during said execution to identify a sequence of basic blocks in dynamic program order;
storing characterization information corresponding to each identified basic block during said execution;
identifying one or more repeated paths during said execution, wherein a path comprises a sequence of basic blocks, wherein each basic block is unique within a corresponding path; and
producing a program profile based upon said execution, wherein said program profile identifies the one or more repeated paths.

2. The method as recited in claim 1, further comprising identifying one or more repeated strata during said execution, wherein a stratum comprises a sequence of repeated paths, wherein each repeated path is unique within a corresponding stratum, and wherein said program profile identifies said one or more repeated strata.

3. The method as recited in claim 2, further comprising identifying one or more stratum layers during said execution, wherein a stratum layer comprises a sequence of repeated stratum, wherein each repeated stratum is unique within a corresponding stratum layer, and wherein said program profile identifies said one or more stratum layers.

4. The method as recited in claim 1, further comprising associating a weight value to each basic block, wherein the weight value corresponds to one or more of the following within the corresponding basic block: a total number of instructions, a number of a certain type of instruction within the corresponding basic block, a total number of clock cycles required for an execution of the basic block, and a total number of cache misses.

5. The method as recited in claim 4, further comprising generating a hot value for each path, wherein said generation comprises summing the weight values for each corresponding basic block to produce a sum and multiplying the sum by a number of dynamic occurrences of the path.

6. The method as recited in claim 4, wherein the stored characterization information comprises one or more of the following: an address of the first instruction of the basic block, the weight value, and disassembly of the instructions.

7. The method as recited in claim 3, further comprising compressing one or more of the following prior to storing: each path, each stratum, each repeated stratum, and each stratum layer.

8. The method as recited in claim 1, wherein said execution is performed without use of a simulator.

9. A computing system comprising:
one or more processors comprising one or more processor cores;
a memory coupled to the one or more processors, wherein the memory stores a program comprising program code;
wherein a processor of the one or more processors is configured to execute program instructions which when executed are operable to:
instrument said program code during execution to identify a sequence of basic blocks in dynamic program order;
store characterization information corresponding to each identified basic block during said execution;
identify one or more repeated paths during said execution, wherein a path comprises a sequence of basic blocks, wherein each basic block is unique within a corresponding path; and
produce a program profile based upon said execution, wherein said program profile identifies the one or more repeated paths.

10. The computing system as recited in claim 9, wherein a processor of the one or more processors is configured to execute program instructions which when executed are operable to identify one or more repeated strata during said execution, wherein a stratum comprises a sequence of repeated paths, wherein each repeated path is unique within a corresponding stratum, and wherein said program profile identifies said one or more repeated strata.

11. The computing system as recited in claim 10, wherein a processor of the one or more processors is configured to execute program instructions which when executed are operable to identify one or more stratum layers during said execution, wherein a stratum layer comprises a sequence of repeated stratum, each repeated stratum is unique within a corresponding stratum layer, and wherein said program profile identifies said one or more stratum layers.

12. The computing system as recited in claim 9, wherein a processor of the one or more processors is configured to execute program instructions which when executed are operable to associate a weight value to each basic block, wherein the weight value corresponds to one or more of the following within the corresponding basic block: a total number of instructions, a number of a certain type of instruction within the corresponding basic block, a total number of clock cycles required for an execution of the basic block, and a total number of cache misses.

13. The computing system as recited in claim 12, wherein a processor of the one or more processors is configured to execute program instructions which when executed are operable to generate a hot value for each path, wherein said generation comprises summing the weight values for each corresponding basic block to produce a sum and multiplying the sum by a number of dynamic occurrences of the path.

14. The computing system as recited in claim 12, wherein the stored characterization information comprises one or more of the following: an address of the first instruction of the basic block, the weight value, and disassembly of the instructions.

15. The computing system as recited in claim 11, wherein a processor of the one or more processors is configured to execute program instructions which when executed are operable to store compressed versions of one or more of the following: each path, each stratum, each repeated stratum, and each stratum layer.

16. The computing system as recited in claim 9, wherein said execution does not utilize a simulator.

17. A computer readable storage medium storing program instructions, wherein the program instructions are executable to:
instrument said program code during execution to identify a sequence of basic blocks in dynamic program order;
store characterization information corresponding to each identified basic block during said execution;
identify one or more repeated paths during said execution, wherein a path comprises a sequence of basic blocks, wherein each basic block is unique within a corresponding path; and
produce a program profile based upon said execution, wherein said program profile identifies the one or more repeated paths.

18. The storage medium as recited in claim 17, wherein the program instructions are further executable to identify one or more repeated strata during said execution, wherein a stratum comprises a sequence of repeated paths, wherein each repeated path is unique within a corresponding stratum, and wherein said program profile identifies said one or more repeated strata.

19. The storage medium as recited in claim 18, wherein the program instructions are further executable to identify one or more stratum layers during said execution, wherein a stratum layer comprises a sequence of repeated stratum, wherein each repeated stratum is unique within a corresponding stratum layer, and wherein said program profile identifies said one or more stratum layers.

20. The storage medium as recited in claim 17, wherein the program instructions are further executable to generate a hot value for each path, wherein said generation comprises summing a weight values for each corresponding basic block to produce a sum and multiplying the sum by a number of dynamic occurrences of the path.
